(19) United States
(12) Patent Application Publication
(10) Pub. No.: US 2025/0328980 A1
(43) Pub. Date: Oct. 23, 2025

(54) GENERATING AND PRESENTING A SELF-AFFINE MATRIX BARCODE

(71) Applicant: Google LLC, Mountain View, CA (US)

(72) Inventor: Stefan Lindmark, Östhammar (SE)

(21) Appl. No.: 18/640,296

(22) Filed: Apr. 19, 2024

(51) Int. Cl. G06T 1/00; G06T 3/02; G06T 9/00; G06T 11/00

(52) U.S. Cl. CPC G06T 1/0028; G06T 3/02; G06T 9/00; G06T 11/00

(57) ABSTRACT

Methods and systems for generating and presenting a self-affine matrix barcode. Data items received are encoded into original graphic symbols. Self-affine graphic symbols are generated based on the original graphic symbols. The self-affine graphic symbols are caused to be visually rendered for presentation to one or more users.

### TECHNICAL FIELD

Aspects and implementations of the present disclosure relate to generating and presenting a self-affine matrix barcode.

### BACKGROUND

Virtual meetings can take place between multiple participants via a virtual meeting platform. A virtual meeting platform can include tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for generating and presenting a self-affine matrix barcode. The method includes receiving, by a processor, a data item. The method further includes encoding the data item into an original graphic symbol. The method further includes generating, based on the original graphic symbol, a self-affine graphic symbol.

In some implementations, the original graphic symbol is represented by a matrix barcode.

In some implementations, at least one portion of self-affine graphic symbol is derived from the original graphic symbol by applying an affine transformation to the original graphic symbol.

In some implementations, the affine transformation is represented by an isotropic affine transformation.

In some implementations, generating self-affine graphic symbol includes initializing self-affine graphic symbol to be equal to the original graphic symbol. Generating self-affine graphic symbol further includes replacing the at least one portion of self-affine graphic symbol with a scaled down version of the original graphic symbol.

In some implementations, the data item comprises a Uniform Resource Identifier (URI).

In some implementations, the data item includes an instruction for connecting to a virtual meeting. In some implementations, causing self-affine graphic symbol to be visually rendered for presentation to one or more users further incudes projecting self-affine graphic symbol on a surface viewable by the one or more users from different distances.

In some implementations, the data item includes an instruction for utilizing an equipment item. In some implementations, causing self-affine graphic symbol to be visually rendered for presentation to one or more users further includes attaching an image of self-affine graphic symbol to the equipment item.

In some implementations, causing self-affine graphic symbol to be visually rendered for presentation to one or more users further includes generating a watermark graphic symbol comprising self-affine graphic symbol. Causing self-affine graphic symbol to be visually rendered for presentation to one or more users further includes incorporating the watermark graphical symbol into content to be presented to the one or more users.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 illustrates an example a matrix barcode component, in accordance with implementations of the present disclosure.

FIG. 3 illustrates an example of a matrix barcode, in accordance with implementations of the present disclosure.

FIG. 4 illustrates an example of a self-affine matrix barcode, in accordance with implementations of the present disclosure.

FIGS. 5A and 5B illustrate an example user interface (UI) with a watermark, in accordance with implementations of the present disclosure.

FIG. 6 depicts a flow diagram illustrating an example method for increasing readability of watermarked content in a virtual meeting, in accordance with implementations of the present disclosure.

FIG. 7 is a block diagram illustrating an exemplary computer system, in accordance with implementations of the present disclosure.

### DETAILED DESCRIPTION

Aspects of the present disclosure relate to generating and presenting a self-affine matrix barcode. A virtual meeting platform (or platform) can include tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. The platform can be used to establish a virtual meeting between multiple participants (e.g., a user of a virtual meeting platform on a client device).

In some instances, the virtual meeting can be a hybrid meeting which combines an in-room event with a virtual online component (one or more participants joining remotely via, for example, a virtual meeting platform). The in-room event can include one or more participants (referred to as “in-room participants”) physically present in a physical location, such as, for example, a meeting room, a venue, an office, etc. The virtual online component can include one or more participants joining remotely (referred to as “remote participants”) via, for example, the virtual meeting platform.

In one example, an in-room participant, may wish to check into the virtual meeting under their name rather than a room identifier. In another example, the in-room participant may wish to join the virtual meeting with their device to improve participants collaboration. Both above-described use cases may be facilitated by displaying, on a display of a hardware device used to connect in-room participants to the virtual meeting or on a surface of the physical location, a graphic symbol (such as barcode) encoding one or more data items (e.g., a meeting identifier, a room identifier, an equipment identifier, and/or other data items). The meeting identifier may be a string of alphanumeric characters that provides access to a participant to connect to the virtual meeting. The room identifier may be a string of alphanumeric characters that provides access to a participant to check into the virtual meeting under their name rather than a name of the physical location. The equipment identifier may be a string of alphanumeric characters that provides to a participant instructions on how to use the equipment in the physical location. In some implementations, the barcode may be a matrix barcode, commonly known as a QR (Quick Response) code, which is a two-dimensional barcode.

However, in both above-described use cases, in-room participants must be within a specific proximity of the graphic symbol, in order to obtain the one or more data items encoded into the graphic symbol. In some instances, to avoid the necessity of in-room participants positioning themselves within the specific proximity graphic symbol, a larger version of the graphic symbol can be visually rendered onto or affixed to the surface of the physical location. However, this solution presents its own set of challenges, graphic symbol visibility of the larger version of the graphic symbol can be compromised by visual obstructions along the optical path located between the imaging device (e.g., the participant's smartphone) and the surface in which the larger version of the graphic symbol graphic symbol is visually rendered onto or affixed to. In another example, an in-room participant positioned in close proximity to larger version of the graphic symbol graphic symbol can only see a portion of the graphic symbol, may need to step back in order to obtain the one or more data items encoded into the graphic symbol.

In another example, one of the participants (e.g., a presenting participant) in the virtual meeting may wish to present content in real-time to other participants of the virtual meeting (e.g., observing participant(s)). The content, whether it is from a user interface (UI) on the presenting participant's client device or any other viewable content in the virtual meeting (like images, videos, documents, or software code), may be subject to confidentiality concerns. To safeguard the content, the presenting participant might choose to add a watermark which is an image with specific transparency levels overlaid on the content. This watermarked content can then be shared with observing participants. However, once shared, the observing participants may attempt to remove or alter the watermark.

Aspects of the present disclosure address the above and other deficiencies by using self-affine images of graphic symbol (e.g., barcodes) that encode the meeting identifier, the room identifier, the equipment identifier, and/or other data items to generate a self-affine graphic symbol that facilitate the above-described use cases.

The self-affinity of the graphic symbol means that the whole graphic symbol is visually similar to each part of itself (i.e., the whole graphic symbol has the same shape as each of its parts). In other words, the graphic symbol includes multiple parts, such that each part is a scaled down version of the graphic symbol itself. In some implementations, the self-affinity may further apply to each part of the original graphic symbol, such that each part in turn includes multiple sub-parts, each of which is a scaled down version of the part (i.e., a further scaled down version of the original graphic symbol).

In some applications, the self-affine graphic symbol can be presented on a large screen in the physical location, visually rendered onto a surface of the physical location, or affixed to the surface of the physical location. Accordingly, even if only a portion of the self-affine graphic symbol is visible by an in-room participant due to their positioning in the physical location or obstructions between them and the surface, the portion of the self-affine graphic symbol can include one or more self-affine images of the graphic symbol that can be used to obtain the meeting identifier, the room identifier, the equipment identifier, and/or other data items encoded into the one or more self-affine images of the graphic symbol by the in-room participant.

In another application, a watermark including the self-affine graphic symbol can be used to protect the confidentiality of content presented in real-time to other participants of the virtual meeting. That is, the self-affine graphic symbol can be configured to have a specific level of transparency and appear over the content. Accordingly, even if a participant of the virtual meeting attempts to remove a substantial portion of the watermark (through zooming and/or cropping), the remaining portions of the watermark including one or more self-affine images of the graphic symbol would remain.

Accordingly, aspects of the present disclosure cover techniques that enable any in-room participant to scan the original QR code from any position within the physical location regardless of the degree of visibility of the QR code due to proximity or obstructions, thus improving the readability and scanability of the QR code, and further reducing the reliance on the error correction capability of the QR code decoding methods to correct errors resulting from the poor image quality and/or partial visibility. Additionally, enabling content embedded with the original QR code as a watermark to be resistant to tampering, particularly through zooming and/or cropping, thereby improving the discovery of exfiltration of the content.

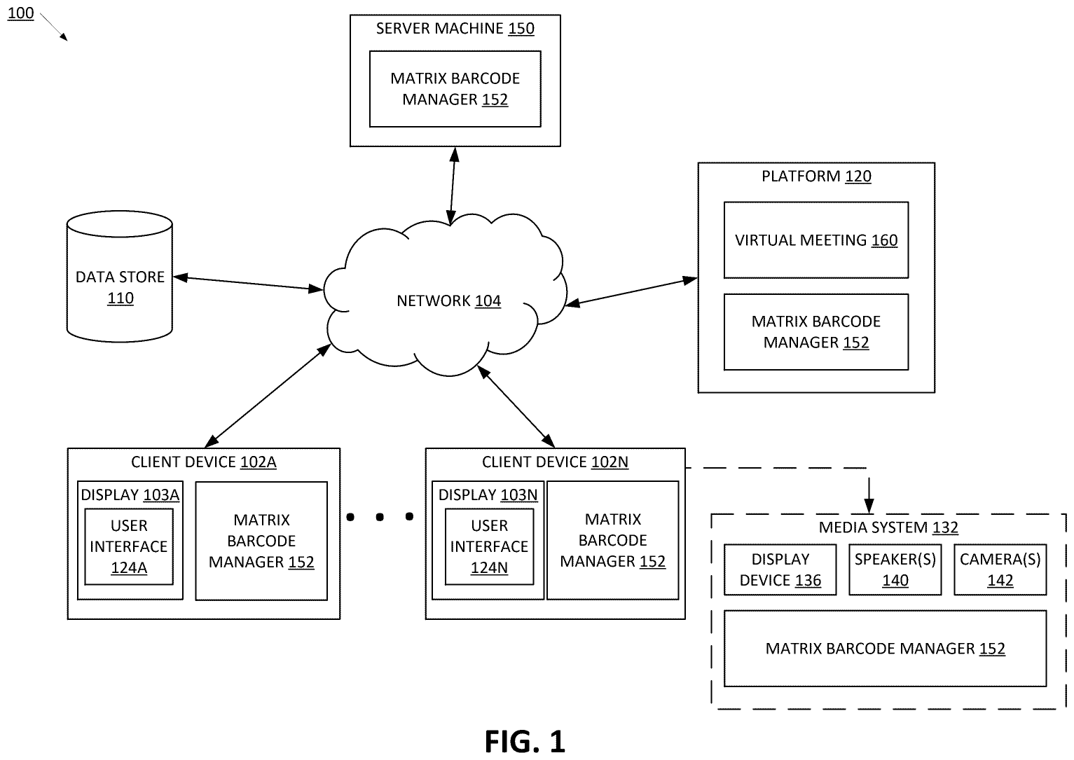

FIG. 1 illustrates an example system architecture 100, in accordance with implementations of the present disclosure. The system architecture 100 (also referred to as “system” herein) includes client devices 102A-N (collectively and individually referred to as client device 102 herein), a data store 110, a platform 120, and/or a server machine 150 each connected to a network 104. In implementations, network 104 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more portions of a document and/or a file displayed via a graphical user interface (GUI) on a client device 102, in accordance with embodiments described herein. Data store 110 can be hosted by one or more storage devices, such as main memory, magnetic or optical storage-based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that can be hosted by platform 120 or one or more different machines coupled to the platform 120 via network 104.

Platform 120 can enable users of client devices 102A-N to connect with each other via a virtual meeting (e.g., virtual meeting 160). A virtual meeting 160 can be a real-time communication session such as a video-based virtual meeting, which includes a meeting during which a client device 102 connected to platform 120 captures and transmits image data (e.g., collected by a camera of a client device 102) and/or audio data (e.g., collected by a microphone of the client device 102) to other client devices 102 connected to platform 120. The image data can, in some embodiments, depict a user or group of users that are participating in the virtual meeting 160. The audio data can include, in some embodiments, an audio recording of audio provided by the user or group of users during the virtual meeting 160. In additional or alternative embodiments, the virtual meeting 160 can be a real-time communication session such as an audio-based virtual meeting, which includes a meeting during which a client device 102 captures and transmits audio data (e.g., without generating and/or transmitting image data) to other client devices 102 connected to platform 120. Real-time communication refers to the ability for users to communicate (e.g., exchange information) instantly without transmission delays and/or with negligible (e.g., milliseconds or microseconds) latency. In some instances, a virtual meeting can include or otherwise be referred to as a conference call. In such instances, a video-based virtual meeting can include or otherwise be referred to as a video-based conference call and an audio-based virtual meeting can include or otherwise be referred to as an audio-based conference call.

In some implementations, the platform 120 (or the server 150) may include a virtual meeting manager (not shown) that can manage a virtual meeting 160 between multiple users of the platform 120. In some implementations, the virtual meeting manager may provide the virtual meeting UIs 124A-124N to each client device 102A-N, 104 to enable users to watch and listen to each other during a virtual meeting 160. The virtual meeting manager can also collect and provide data associated with the virtual meeting 160 to each participant of the virtual meeting 160. In some implementations, the virtual meeting manager can determine visual items for presentation in the UIs 124A-124N during a virtual meeting 160. A visual item can refer to a UI element that occupies a particular region in the UI 124A-124N and is dedicated to presenting a video stream from a respective client device. Such a video stream can depict, for example, a user of the respective client device 102A-N, 104 while the user is participating in the virtual meeting 160 (e.g., speaking, presenting, listening to other participants, watching other participants, etc., at particular moments during the virtual meeting 160), a physical conference or meeting room (e.g., with one or more participants present), a document or media content (e.g., video content, one or more images, etc.) being presented during the virtual meeting 160, etc. The visual items for presentation can be determined based on current speaker, current presenter, order of the participants joining the virtual meeting 160, list of participants (e.g., alphabetical), configuration settings, etc. The UI 124A-124N can include multiple regions. Each region can display a visual item corresponding to a video stream pertaining to one or more participants of the virtual meeting 160. The virtual meeting manager can control which video stream's visual item is to be displayed in a specific region of a virtual meeting UI 124A-124N. The virtual meeting manager may generate the UIs 124A-124N for the different client devices 102A-102N, 104 and provide the UIs 124A-124N to the client devices 102A-102N, 104. The virtual meeting manager may generate different UIs 124A-124N for different client devices 102A-102N, 104. In some implementations, the virtual meeting manager may generate partial virtual meeting UIs 124A-124N for client applications of client devices 102A-102N, 104, and the client applications may finalize the UIs 124A-124N for display on the displays 103A-103N.

In some implementations, the virtual meeting platform 120 or the server 150 can include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a virtual meeting 160. The virtual meeting platform 120 can also include a website (e.g., one or more webpages) or application back-end software that can be used to enable a user to connect with other users by way of the virtual meeting 160.

The client devices 102A-N can each include computing devices such as personal computers (PCs), laptops, mobile phones, smart phones, tablet computers, netbook computers, network-connected televisions, etc. In some implementations, client devices 102A-N can also be referred to as “user devices.” A client device 102 can include an audiovisual component that can generate audio and video data to be streamed to conference platform 120. In some implementations, the audiovisual component can include one or more devices (e.g., a microphone, etc.) that capture an audio signal representing audio provided by the user. The audiovisual component can generate audio data (e.g., an audio file or audio stream) based on the captured audio signal. In some embodiments, the audiovisual component can additionally or alternatively include one or more devices (e.g., a speaker) that output data to a user associated with a particular client device 102. In some embodiments, the audiovisual component can additionally or alternatively include an image capture device (e.g., a camera) to capture images and generate image data (e.g., a video stream) of the captured images.

In some embodiments, one or more client devices 102 can be devices of a physical conference room or a meeting room. Such client devices 102 can be included at or otherwise coupled to a media system 132 that includes one or more display devices 136, one or more speakers 140 and/or one or more cameras 142. A display device 136 can be or otherwise include a smart display or a non-smart display (e.g., a display that is not itself configured to connect to platform 120 or other components of system 100 via network 104). Users that are physically present in the conference room or the meeting room can use media system 132 rather than their own client devices 102 to participate in a virtual meeting, which can include other remote participants. For example, participants in the conference room or meeting room that participate in the virtual meeting can control display 136 to share a slide presentation with, or watch a slide presentation of, other participants that are accessing the virtual meeting remotely. Sound and/or camera control can similarly be performed. As described above, a client device 102 connected to a media system 132 can generate audio and video data to be streamed to platform 120 (e.g., using one or more microphones (not shown), speaker(s) 140 and/or camera(s) 142).

Client devices 102A-N can each include a client application, in some embodiments. A client application can be a mobile application, a desktop application, a web browser, etc. In some implementations, the client application can present, on a display device 103A-103N of a client device 102A-102N, a user interface (UI) (sometimes referred to as a graphical user interface (GUI)) for users to access a virtual meeting 160 hosted by platform 120. In one or more examples, a user of client device 102A can join and participate in a virtual meeting 160 via UI 124A presented on display 103A via the client application. A user can also present or otherwise share content to other participants of the virtual meeting 160 via each of UIs 124A-124N. Each of UIs 124A-124N can include multiple regions that enable presentation of visual items corresponding to video streams of client devices 102A-102N provided to platform 120 during the virtual meeting 160.

In some embodiments, platform 120 can include a matrix barcode component 152. Matrix barcode component 152 can be configured to generate a self-affine graphic symbol (e.g., a matrix barcode) that encodes one or more data items (e.g., the meeting identifier, the room identifier, the equipment identifier, etc.) Each of the data items may be formatted as text or a uniform resource identifier (URI).

Matrix barcode component 152 can encode the data item into an original graphic symbol. More specifically, as will be described in further detail below, matrix barcode component 152 generates a square grid including a plurality of modules. Matrix barcode component 152 includes, in the square grid, patterns such as finder patterns, separators, timing patterns, alignment patterns, format patterns each represented as a combination of black and white modules. Matrix barcode component 152 encodes the data item. Matrix barcode component 152 generates error corrections codes used to correct any errors that can occur with the encoded data item. Matrix barcode component 152 inserts, in a data area of the square grid, a visual pattern that includes the encoded data item and the error correction codes.

Matrix barcode component 152 can then modify the original graphic symbol to generate a self-affine graphic symbol. More specifically, matrix barcode component 152 generates a scaled down version of the original graphic symbol (or smaller original graphic symbol) using an affine transformation, such as, an isotropic affine transformation. An affine transformation is a fundamental concept in geometry and cornputer graphics, representing a class of linear mapping method used to transform points in a coordinate space. The affine transformation includes operations such as scaling, rotating, translating, and shearing of points in a space. The affine transformation preserves points, straight lines, planes, and parallelism of parallel lines. The isotropic affine transformation is a linear transformation that modifies the scales of the original graphic symbol equally in every dimension, thus preserving the angles of the original graphic symbol. Matrix barcode component 152, as will be described in further detail below, generates a square grid of a plurality of modules for the self-affine graphic symbol that is substantially equivalent to the square grid of the original graphic symbol. Matrix barcode component 152 identifies each module of the original graphic symbol that contains a black module and inserts, in a corresponding module of the square grid of the self-affine graphic symbol, the smaller original graphic symbol.

Matrix barcode component 152 can further self-affine the self-affine graphic symbol. In particular, matrix barcode component 152 can set a predetermined number of self-affine iterations. Each iteration of the self-affine iterations, the matrix barcode component 152 generates an even smaller original graphic symbol (i.e., an original graphic symbol that is smaller than the previous iteration of the self-affine). Matrix barcode component 152 identifies each module of the self-affine graphic symbol (i.e., the self-affine graphic symbol generated from the previous iteration of the self-affine) that contains a scaled down version of the original graphic symbol from the previous iteration of the self-affine and inserts, for each pixel of the scaled down version of the original graphic symbol from the previous iteration of the self-affine, the even smaller original graphic symbol.

In some embodiments, matrix barcode component 152 may generate, using the predetermined number of self-affine iterations, a smallest scaled down version of the original graphic symbol (e.g., a fundamental graphic symbol). More specifically, matrix barcode component 152 using the isotropic affine transformation scales down the original graphic symbol by a factor of the predetermined number of self-affine iterations. Matrix barcode component 152 generates a square grid of a plurality of modules for the self-affine graphic symbol that is substantially equivalent to the square grid of the original graphic symbol. Matrix barcode component 152 determines a number of fundamental graphic symbols that can occupy a module of the self-affine graphic symbol (e.g., a fixed number of fundamental graphic symbols). Matrix barcode component 152 identifies each module of the original graphic symbol that contains a black module and inserts, in a corresponding module of the square grid of the self-affine graphic symbol, the fixed number of fundamental graphic symbols. The fixed number of fundamental graphic symbols are arranged to occupy the entire corresponding module of the square grid of the self-affine graphic symbol.

Matrix barcode component 152 visually renders the self-affine graphic symbol on display 136 of the media system 132. Media system 132 can further visually render a larger version of the self-affine graphic symbol on an external display or project the larger version of the self-affine graphic symbol on a surface of the physical location for participants in the physical location. In another embodiment, the self-affine graphic symbol may be transferred onto a physical medium, such as, for example a paper or label, that can be affixed to any surface or equipment item. In yet another embodiment, matrix barcode component 152 can generate a watermark using the self-affine graphic symbol which is superimposed on shared content, one or more UIs of UIs 124A-124N of the virtual meeting, or a portion of the one or more UIs of UIs 124A-124N. Further details regarding matrix barcode component 152 are provided herein.

Although FIG. 1 illustrates matrix barcode component 152 as part of platform 120, in additional or alternative embodiments, matrix barcode component 152 can reside on one or more server machines that are remote from platform 120 (e.g., server machine 150). in some implementations, the functions of platform 120, and/or server machine 150 can be provided by more or a fewer number of machines. For example, in some implementations, components and/or modules of platform 120, and/or server machine 150 can be integrated into a single machine, while in other implementations components and/or modules of any of platform 120, and/or server machine 150 can be integrated into multiple machines. In addition, in some implementations, components and/or modules of and/or server machine 150 can be integrated into platform 120.

In general, functions described in implementations as being performed platform 120, and/or server machine 150 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of a virtual meeting platform 120 and users of platform 120 accessing a virtual meeting 160 hosted by platform 120, aspects of the disclosure are not limited to virtual meeting platforms and can be extended to any type of platforms. For example, aspects of the present disclosure can be used for video playback, image display, product prototype demonstrations, etc.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user can be provided with controls allowing the user to make an election as to both if and when systems, programs, or features described herein can enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

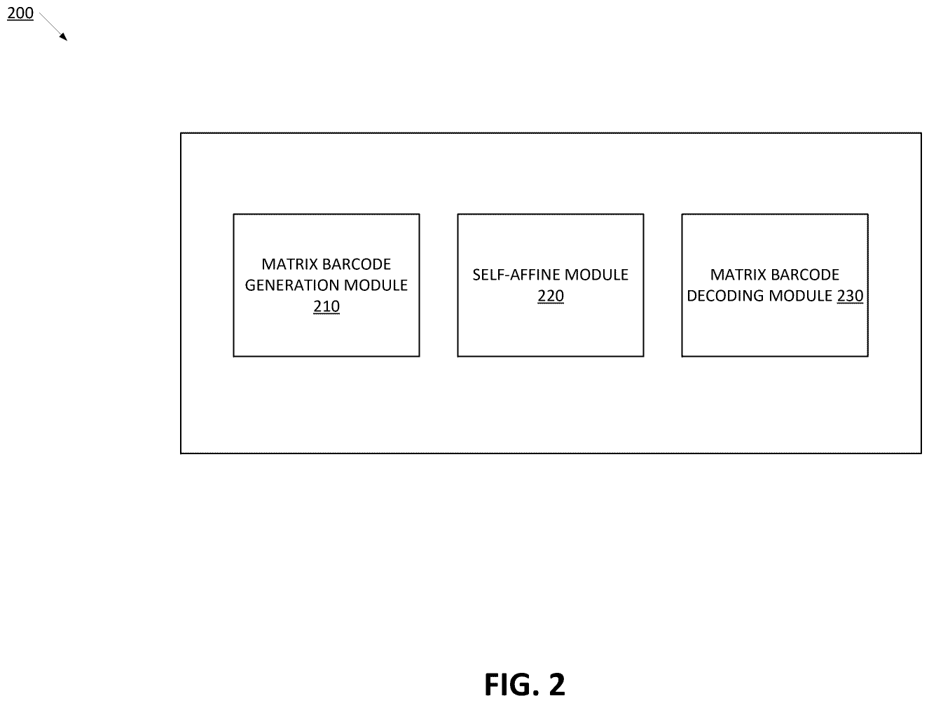

FIG. 2 illustrates an example matrix barcode component 200, similar to matrix barcode component 152 of FIG. 1 described above. Matrix barcode presentation component 200 includes a matrix barcode generation module 210, a self-affine module 220, and a matrix barcode decoding module 230.

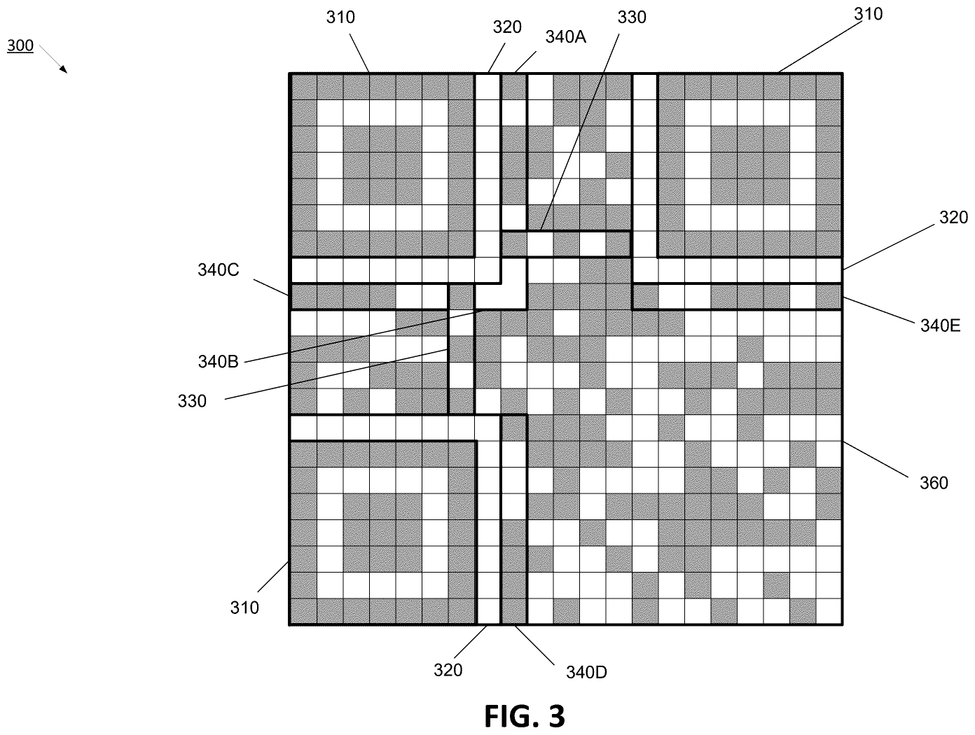

Matrix barcode component 200 can receive a data item to be encoded into a graphic symbol (e.g., a QR code). The data item is provided to the matrix barcode generation module 210 to generate an original QR code. Matrix barcode generation module 210 receives the data item. Matrix barcode generation module 210 determines a size for the original QR code (e.g., original QR code of FIG. 3). The size is dependent on a distance from which the original QR code will be scanned. The larger the scanning distance, the bigger the original QR code should be. Determining the size can be calculated based on a ratio of the scanning distance to the size of the original QR code (e.g., at least 10:1). In other words, the size of the original QR code should be at least equal to a scanning distance divided by 10. For example, if the expected scanning distance is 50 inches (127 cm), then the size of the original QR code should be at least 5 inches by 5 inches (12.7 cm by 12.7 cm) or 480 pixels.

Matrix barcode generation module 210 generates, based on the size of the original QR code, a square grid 300 of FIG. 3 (referred to simply as “grid”) with individual squares referred to as modules. Matrix barcode generation module 210 can dictate, using a module configuration, a number of modules within grid 300. The module configuration can range from 21 modules×21 modules to 177 modules×177 modules.

Matrix barcode generation module 210 constructs a finder pattern 310 to be insert in one or more corners of grid 300 to help identify and orient the original QR code correctly. For example, the finder pattern 310 can be inserted in a top left corner, a top right corner, and a bottom left corner of grid 300. The finder pattern 310 is a large square pattern which is typically based on a 3×3 matrix of black modules surrounded by white modules that are again surrounded by black modules (e.g., an outer modules of the finder pattern 310).

Matrix barcode generation module 210 can insert, in grid 300, a separator 320 for each finder pattern 310 to improve the readability of the finder pattern(s) 310. The separator 320 improves the readability of the finder pattern(s) 310 by separating the finder pattern(s) 310 from a data area 360. Each separator 320 surrounds the outer modules of the finder pattern 310 and is a color (e.g., white) that contrasts with a color of the outer modules of the finder pattern 310 (e.g., black).

Matrix barcode generation module 210 can insert, in grid 300, a timing pattern 330 between finder pattern(s) 310 to help the decoder determine the size of each module in grid 300. For example, a timing pattern 330 can be inserted between finder pattern(s) 310 located in the top left corner and top right corner and between finder pattern 310 located in the top left corner and bottom left corner. Each timing pattern 330 is a series of alternating black and white modules.

Matrix barcode generation module 210 can insert, in grid 300, one or more alignment pattern(s) (not shown) to help the decoder compensate for distortion (e.g., due to curved surfaces) to allow the original QR code to be scannable from all angles and directions. Each alignment pattern is a small square pattern, in comparison to the finder pattern 310, and is typically based on a 1×1 matrix of black modules surrounded by white modules that are again surrounded by black modules. The number of one or more alignment pattern(s) inserted in grid 300 can vary depending on the amount of information the original QR code contains. Accordingly, the larger the original QR code is, the more alignment markers it will contain.

Matrix barcode generation module 210 can insert, in grid 300, one or more copies of a format pattern (e.g., format patterns 340A-E) to help make the QR code easier to read and scan. Each copy of the format patterns 340A-E includes format information such as an error tolerance level and a data mask for the original QR code represented by one or more modules. Each copy of the format patterns 340A-E surrounds a separator 320 of the one or more separator(s) 320.

The error tolerance level refers to the ability to withstand and correct errors due to damage or distortion. QR codes are designed with built-in error correction capabilities, which are categorized into four levels (e.g., Level L (Low), Level M (Medium), Level Q (Quartile), or Level H (High)). Each level offers a different degree of error tolerance, balancing between the amount of data that can be stored and the code's resilience to damage. The error tolerance level further affects the number of modules required to encode the data. Higher error correction levels, the more space for the error correction codes, reducing the space available for actual data.

Level L (Low) provides approximately 7% error correction capacity and is the least robust in terms of error correction but allows for the most data to be stored. Level M (Medium) provides approximately 15% error correction capacity and is a reasonable balance between data capacity and tolerance to damage. Level Q (Quartile) provides approximately 25% error correction capacity and is more robust against damage. Level H (High) provides approximately 30% error correction capacity and is the most robust against significant damages but stores less data compared to the other levels.

Data mask is applied to the encoded data item to ensure optimal readability and scanability. There are eight standard types of data masks used in QR codes (e.g., Mask 0 through Mask 7), each with a different pattern. During generation of the QR code each of the masks are evaluated against the encoded data item to select one that minimizes the occurrence of large areas of the same color and complex patterns. The chosen data mask is then applied to the modules in the data area 360 using an Exclusive OR (XOR) operation for a balanced and uniform appearance.

Mask 0 (e.g., a horizontal stripe pattern) inverts every module in a row whose index is divisible by 2. Mask 1 (e.g., a vertical stripe pattern) inverts every module in a column whose index is divisible by 3. Mask 2 (e.g., a diagonal stripe pattern) inverts every module where the sum of the row and column numbers is divisible by 3. Mask 3 (e.g., a complex checkerboard-like pattern) inverts every module where the sum of the row and column indexes is divisible by 2 or 3. Mask 4 inverts every module where the modulus 2 of the floor division of the row index by 2 and the floor division of the column index by 3 equals 0. Mask 5 inverts every module if the modulus 2 of the product of row and column indexes equals 0. Mask 6 (e.g., a chess board pattern with smaller squares) inverts every module where the modulus 2 of the sum of the floor division of row and column indexes by 2 equals 0. Mask 7 inverts every module where the modulus 2 of the sum of the floor division of row index by 2 plus the floor division of column index by 3 equals 0.

Matrix barcode generation module 210 can designate the remaining portion of grid 300 as a data area which can be used to store encoded data items and error correction codes. With quick reference to FIG. 3, data area 360 includes the portion of grid 300 excluding the finder pattern 310, separator(s) 320, timing pattern(s) 330, alignment pattern(s), and the one or more copies of the format pattern 340A-E. Returning now to FIG. 2, matrix barcode generation module 210 converts the data item into a binary format (e.g., binary data) based on the encoding mode (numeric, alphanumeric, byte/binary, or kanji). Each encoding mode has specific rules for conversion. Numeric encoding mode encodes numerical data only. Alphanumeric encoding mode encodes a set of 45 characters. Byte or binary encoding mode encodes data in bytes. Specific language encoding mode, such as kanji encoding mode encodes characters from character sets of the specific language.

Matrix barcode generation module 210 generates error correction codes, such as Reed-Solomon codes, to be included in the data by representing the binary data as a polynomial. Each coefficient of the polynomial corresponds to a byte of data item. A generator polynomial, specific to a chosen error tolerance level, is used to create the error correction codes. The data polynomial is multiplied by the generator polynomial. The resulting polynomial is divided by a predefined modulus polynomial. The remainder from this division is converted into binary format and forms the error correction codes.

Matrix barcode generation module 210 can integrate the error correction codes with the binary data. For example, the matrix barcode generation module 210 can append the error correction codes to the binary data to form a binary string. Matrix barcode generation module 210 translates the binary string into a physical pattern to be inserted into grid 300. For example, each binary digit of the binary string translates a module of grid 300 to black (e.g., if binary digit is “1”) or white (e.g., if binary digit is “0”), or vice versa. Each module of grid 300 to be translated by a binary digit of the binary string is selected from a starting position (e.g., a bottom right of grid 300), proceeding upwards in a zigzag pattern (e.g., filling upwards in a column of two modules wide) until a top of grid 300 is reached, shifts leftward by one column, proceeds downwards in a similar zig zag pattern (e.g., filling downwards in a column of two modules wide) until the bottom of grid 300 is reached, and repeats until no more modules are available in the data area 360 or the end of the binary string is reached.

Matrix barcode generation module 210 can apply a data mask (e.g., one of Mask 0-7) to the data area 360 to break up any problematic patterns that might arise during encoding which makes the original QR code more uniformly distributed in terms of black and white modules. Matrix barcode generation module 210 provides the original QR code to self-affine module 220 to be self-affine.

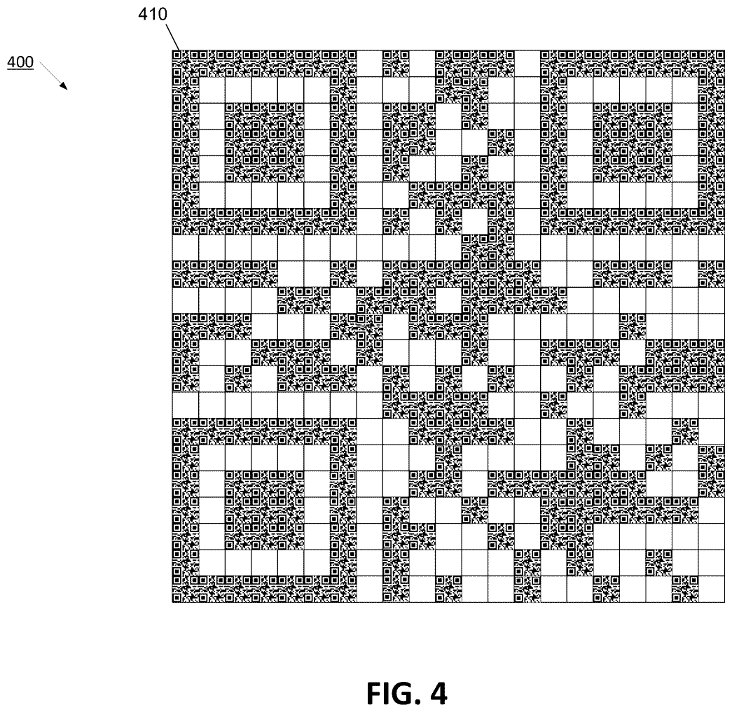

Self-affine module 220 receives the original QR code to self-affine and generate a self-affine QR code. Self-affine refers to a process of composing a QR code that is exactly or approximately similar to a part of itself (i.e., the whole has the same shape as one or more of the parts). Self-affine module 220 generates, based on a size and module configuration of the original QR code, grid 400 of FIG. 4 which is substantially equivalent to grid 300 of FIG. 3 of the original QR code. Self-affine module 220 generates a transformed version of the original QR code (e.g., a scaled down version of the original QR code).

Self-affine module 220 generates the scaled down version of the original QR code (or a smaller original QR code 410 of FIG. 4) by performing an affine transformation on the original QR code. In some embodiments, the affine transformation can be isotropic which scales the original QR code equally in every dimension using a scaling factor to maintain the aspect ratio and shape of the original QR code. The isotropic affine transformation is mathematically represented as:

T(x)=Ax+b, (1)

where T(x) represents the transformed coordinates after applying the affine transformation, x is the vector of original coordinates before the transformation, A is a matrix that represents the linear part of the transformation, which can include scaling factor, rotation, and/or shearing; and b is a vector that represents the translation.

The smaller original QR code 410, represented as T(x), is calculated by multiplying the original QR code, represented as x, with a scaling factor set to an inverse of a width of the original graphic symbol (e.g., 21 module wide), represented as A. It should be noted that, in the current example, since the transformed version of the original QR code is a smaller original QR code, b will be set to zero to avoid any further translation.

Self-affine module 220 populates grid 400 with the smaller original QR code 410. More specifically, self-affine module 220 traverse through the original QR code and identifies each black module in grid 300 of the original QR code. Self-affine module 220, for each black module in grid 300 of the original QR code, inserts the smaller original QR code 410 in a corresponding module of grid 400 of self-affine QR code. The self-affine module 220 provides self-affine QR code to the presentation module 230.

In some embodiments, self-affine module 220 can determine that the self-affine QR code should be further self-affine based on a predetermined number of iterations for self-affine module 220 (or self-affine iterations). That is, the original graphic symbol can be self-affine the predetermined number of iterations. The predetermined number of iterations can be a default value (e.g., 3) or provided by a user of the media system 132. The predetermined number of iterations provided by a user of the media system 132 can be based on a minimum scanning distance and a maximum scanning distance of the physical location.

Self-affine module 220, for each iteration of the predetermined number of iterations, generates a further scaled down version of the original QR code (e.g., an even smaller original QR code). Similar, to above, the even smaller original QR code, represented as T(x), is calculated by multiplying the original QR code, represented as x, with a scaling factor set to an inverse of a width of the original graphic symbol to the power of a respective iteration (i.e., the second iteration would be to the power of 2) (e.g., 21 module wide to the power of 2), represented as A.

Self-affine module 220 replaces, in the grid, each black module of the smaller original QR code (e.g., the smaller original QR code 410) with the even smaller original QR code. Self-affine module 220 repeats the process of generating an exponentially smaller original QR code and replacing each black module present in self-affine QR code until the predetermined number of iterations is reached. Once the predetermined number of iterations is reached, self-affine module 220 provides self-affine QR code to the presentation module 230.

Depending on the embodiment, rather than performing self-affine for the predetermined number of iterations on the original QR code, self-affine module 220 determines the predetermined number of iterations. Self-affine module 220 generates a scaled down version of the original QR code (e.g., a fundamental QR code). Similar, to above, the fundamental QR code, represented as T(x), is calculated by multiplying the original QR code, represented as x, with a scaling factor set to an inverse of a width of the original graphic symbol to the power of the predetermined number of iterations (i.e., if the predetermined number of iterations is set to 3, the power would be 3) (e.g., 21 module wide to the power of 3), represented as A.

Self-affine module 220 populates the grid with the fundamental QR code. More specifically, self-affine module 220 determines a number of fundamental QR codes that can populate a module of the grid of the self-affine QR code. Self-affine module 220 traverse through the original QR code and identifies each black module in the grid of the original QR code. Self-affine module 220, for each black module in the grid of the original QR code, inserts the number of fundamental QR codes in a corresponding module of grid 400 of self-affine QR code. Self-affine module 220 causes matrix barcode component 200 to return the self-affine QR code to be presented.

Presentation of the self-affine QR code can include, for example, visually rendering on an external display, projecting onto a surface, affixing to a surface or equipment item, or applying as a watermark to shared content.

Matrix barcode component 200 can receive an image of a QR code captured by an image capture device of client device 102 of FIG. 1. Matrix barcode decoding module 230 locates, in the image, finder patterns to help recognize the shape, boundary, and orientation of a QR code in the image (e.g., a captured QR code). If the image is the self-affine QR code, matrix barcode decoding module 230 identifies the finder patterns of the self-affine QR code. If the image is a portion of the self-affine QR code, matrix barcode decoding module 230 identifies finder patterns in a smaller QR code in the portion of the self-affine QR code.

Matrix barcode decoding module 230 aligns an internal grid with a grid of the captured QR code using alignment pattern(s) to help correct for any distortions due to curves or angling. Matrix barcode decoding module 230 read each module from a data area of the captured QR code and converts it back into a binary string (including binary data and error correction codes) based on its color (e.g., black module to ‘1’ and white module to ‘0’). The binary string, as noted above, includes binary data and error correction codes.

Matrix barcode decoding module 230 applies the inverse of the data mask used to generate the captured QR code. Matrix barcode decoding module 230 obtains the data mask used to generate the captured QR code by reading the format pattern in the captured QR code. Matrix barcode decoding module 230 applies an error correcting algorithm, such as the reed-solomon error correction to the binary string to correct errors or missing data of the captured QR code. The error correcting algorithm check for inconsistencies between the binary data and the error correction codes of the binary string, which indicates that one or more errors have occurred. The error correcting algorithm treats the binary data as coefficients of a polynomial and solves polynomial equations to identify which bits of the binary data are erroneous. Once the erroneous bits of the binary data are determined, the algorithm can correct them, reverting them to their original state.

Matrix barcode decoding module 230 translates the binary data back into the original data item (such as text, a URL, etc.). Matrix barcode decoding module 230 obtains the encoding mode (numeric encoding mode, alphanumeric encoding mode, byte/binary encoding mode, or kanji encoding mode) used to encode the data item by reading the format pattern. Matrix barcode decoding module 230 causes matrix barcode component 200 to return the decoded information to the user of the client device 102 of FIG. 1.

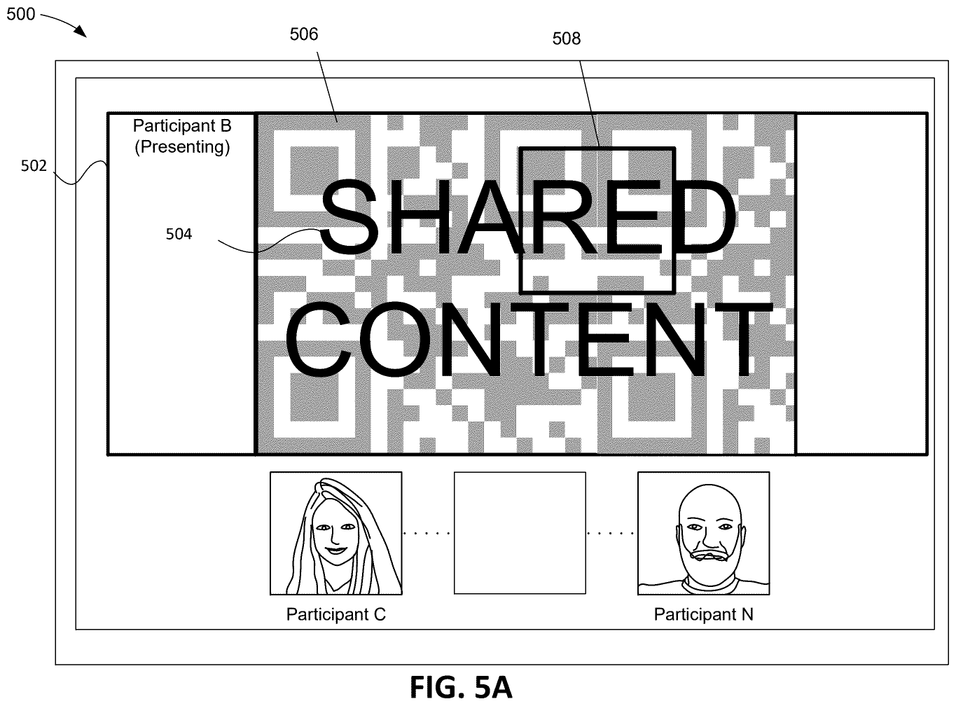

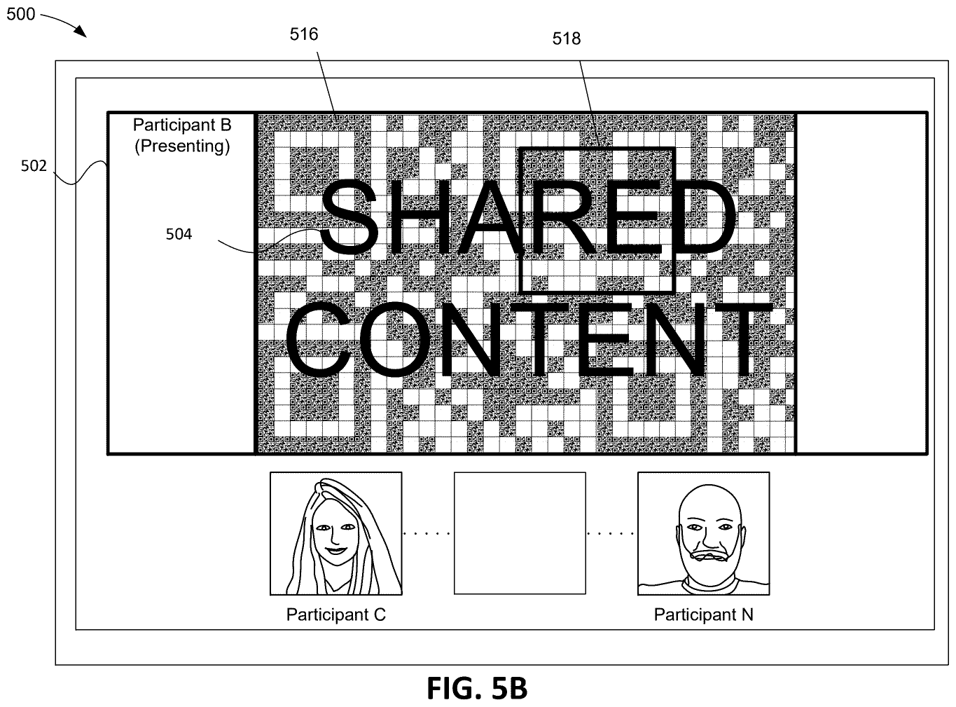

FIGS. 5A and 5B illustrates a user interface (UI) of a virtual meeting, similar to virtual meeting 160 of FIG. 1, between multiple participants via a platform, similar to platform 120 of FIG. 1, in accordance with implementations of the present disclosure. As described above, platform 120 provides a UI 500 to enable participants (e.g., participants A-N) to join and participate in the virtual meeting 160. UI 500 is described as a UI displayed on a client device 102 associated with Participant A of virtual meeting 160. However, UI 500 can be displayed on a client device associated with any participant of virtual meeting 160. During the virtual meeting 160, Participant B of virtual meeting 160 can share content 404. As previously described, content can include a document (e.g., a presentation), a media item (e.g., a video playback or image), a video stream of Participant B, or a software product.

With reference to FIG. 5A, the shared content 504, UI region 502, or a substantial portion of UI 500 can be superimposed with watermark 506. Watermark 506 can include an original QR code, similar to original QR code of FIG. 3. The original QR code may include text or information identifying the participant viewing the shared content 504 (e.g., Participant A). Participant A may attempt to leak the shared content 504 to individuals outside the virtual meeting 160 who lack authorization. In order to evade detection, Participant A can zoom and crop into shared content 504 to generate a segmented portion of shared content 504 (e.g., segmented portion 508). Once segmented portion 508 is leaked, Participant B or any individual assigned to identify the source of the leak, might encounter difficulty pinpointing the source. This is due to the fact that the leaked segmented portion 508 can lack critical features of the original QR code of watermark 506 necessary for decoding, such as the finder pattern, timing patterns, alignment patterns, format patterns, etc. If the portion of the original QR code included in the leaked segmented portion 508 cannot be scanned and/or decoded, obtaining the text or information indicating the participant who leaked the shared content 504 from the original QR code becomes unattainable.

With reference to FIG. 5B, the shared content 504, UI region 502, or a substantial portion of UI 500 can be superimposed with watermark 516. Watermark 516 can include includes an a self-affine QR code, similar to the self-affine QR code of FIG. 4. The self-affine QR code includes a plurality of scaled down versions of the original QR codes (simply plurality of original QR codes). Each scaled down version of the original QR code can include text or information identifying the participant viewing the shared content 504 (e.g., Participant A). Participant A may attempt to leak the shared content 504 to individuals outside the virtual meeting 160 who lack authorization. In order to evade detection, Participant A can zoom and crop into shared content 504 to generate a segmented portion of shared content 504 (e.g., segmented portion 518). Once segmented portion 518 is leaked, Participant B or any individual assigned to identify the source of the leak, can pinpoint the source. This is due to the fact that while the leaked segmented portion 518 excludes a substantial portion of the self-affine QR code of watermark 516, the leaked segmented portion 518 can still include one or more scaled down version of the original QR code that can be scanned and decoded. If at least one scaled down version of the original QR codes in the leaked segmented portion 518 can be decoded, obtaining the text or information indicating the participant who leaked the shared content 504 from the self-affine QR code becomes attainable.

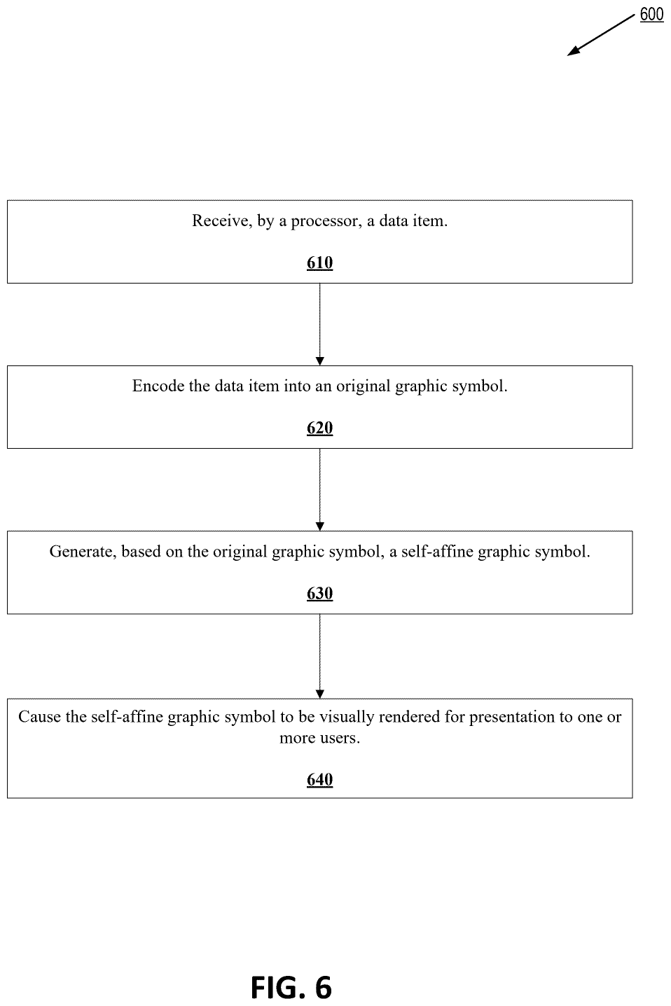

FIG. 6 depicts a flow diagram of an example method 600 for generating and presenting a self-affine graphic symbol, in accordance with implementations of the present disclosure. Method 600 can be performed by processing logic that can include hardware (circuitry, dedicated logic, etc.), software (e.g., instructions run on a processing device), or a combination thereof. In one implementation, some, or all of the operations of method 600 can be performed by one or more components of system 100 of FIG. 1. In some embodiments, some, or all of the operations of method 600 can be performed by matrix barcode component 152 of FIG. 1 and/or matrix barcode component 200 of FIG. 2, as described above.

At block 610, the processing logic receives, by a processor, a data item. As previously described, the data item can the meeting identifier, the room identifier, the equipment identifier, etc. The data item may be formatted as text or a uniform resource identifier (URI).

At block 620, the processing logic encodes the data item into an original graphic symbol. The original graphic symbol can be represented by a matrix barcode. As previously described, encoding the data item into the original graphic symbol can include generating a square grid including a plurality of modules. Patterns, such as finder patterns, separators, timing patterns, alignment patterns, and format patterns, each represented as a combination of black and white modules, are included in the square grid. Data item is encoded and combined with error correction codes. The combined encoded data item and error correction codes are converted into a physical pattern, represented as a combination of black and white modules, and inserted into the data area of the square grid.

At block 630, the processing logic generates, based on the original graphic symbol, a self-affine graphic symbol. The processing logic initializes the self-affine graphic symbol to be equal to the original graphic symbol. As previously described, a square grid is generated for the self-affine graphic symbol that is substantially equivalent in size to the original graphic symbol. At least one portion of the self-affine graphic symbol is generated from the original graphic symbol by applying an affine transformation to the original graphic symbol. The affine transformation is represented by an isotropic affine transformation.

In some embodiments, as previously described, the affine transformation (e.g., isotropic affine transformation) generates a scaled down version of the original graphic symbol. For each black module of the original graphic symbol, the scaled down version of the original graphic symbol is inserted into a corresponding module of the square grid of the self-affine graphic symbol. In other words, the corresponding module of the square grid of the self-affine graphic symbol is replaced with the scaled down version of the original graphic symbol.

Depending on the embodiment, as previously described, the processing logic can determine that the self-affine graphic symbol is set to self-affine a predetermined number of iterations (or self-affine iterations). Thus, each iteration of the self-affine generates an even smaller original graphic symbol and replaces each black module of the scaled down version of the original graphic symbol of the self-affine graphic symbol with the even smaller original graphic symbol.

In some embodiments, as previously described, the affine transformation (e.g., isotropic affine transformation) generates a fundamental graphic symbol which is a smallest scaled down version of the original graphic symbol. The affine transformation using the predetermined number of iterations (or self-affine iterations) in an equation corresponding to the affine transformation to generate the fundamental graphic symbol. The processing logic determines a number of fundamental graphic symbols that can occupy a module of the self-affine graphic symbol (e.g., a fixed number of fundamental graphic symbols). For each black module of the original graphic symbol, the processing logic the fixed number of fundamental graphic symbols are arranged to fully occupy a corresponding module of the square grid of the self-affine graphic symbol.

At block 640, the processing logic causes the self-affine graphic symbol to be visually rendered for presentation to one or more users. In some embodiment, the self-affine graphic symbol is visually rendered on an external display and/or projected on a surface viewable by the one or more users from different distances. In some embodiments, the self-affine graphic symbol can be transferred to a physical medium and attached to a surface and/or equipment item (e.g., media system). In some embodiments, a watermark graphic symbol (or watermark) including the self-affine graphic symbol and superimposed on to content to be presented during the virtual meeting, or at least a portion of the UI of the virtual meeting.

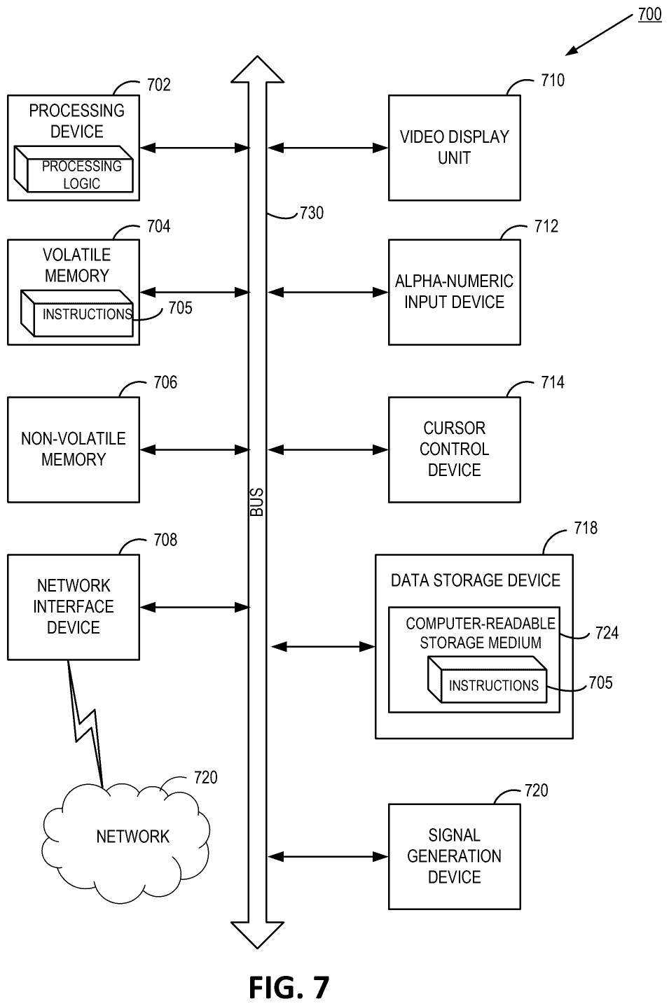

FIG. 7 is a block diagram illustrating an exemplary computer system 700, in accordance with implementations of the present disclosure. The computer system 700 can correspond to platform 120 and/or client devices 102A-N, described with respect to FIG. 1. Computer system 700 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 718, which communicate with each other via a bus 740.

Processor (processing device) 702 represents one or more general-purpose processing devices such as a microprocessor, central processing unit, or the like. More particularly, the processor 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 can also be one or more special-purpose processing devices such as an application specific integrated circuit (ASIC), a field programmable gate array (FPGA), a digital signal processor (DSP), network processor, or the like. The processor 702 is configured to execute instructions 705 (e.g., improving precision of content matching systems at a platform) for performing the operations discussed herein.

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 720 (e.g., a speaker).

The data storage device 718 can include a non-transitory machine-readable storage medium 724 (also computer-readable storage medium) on which is stored one or more sets of instructions 705 (e.g., improving precision of content matching systems at a platform) embodying any one or more of the methodologies or functions described herein. The instructions can also reside, completely or at least partially, within the main memory 704 and/or within the processor 702 during execution thereof by the computer system 700, the main memory 704 and the processor 702 also constituting machine-readable storage media. The instructions can further be transmitted or received over a network 730 via the network interface device 708.

In one implementation, the instructions 705 include instructions for providing fine-grained version histories of electronic documents at a platform. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “some embodiments” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method, comprising:
receiving, by a processor, a data item;
encoding the data item into an original graphic symbol;
generating, based on the original graphic symbol, a self-affine graphic symbol; and
causing the self-affine graphic symbol to be visually rendered for presentation to one or more users.

2. The method of claim 1, wherein the original graphic symbol is represented by a matrix barcode.

3. The method of claim 1, wherein at least one portion of the self-affine graphic symbol is derived from the original graphic symbol by applying an affine transformation to the original graphic symbol.

4. The method of claim 3, wherein the affine transformation is represented by an isotropic affine transformation.

5. The method of claim 3, wherein generating the self-affine graphic symbol further comprises:
initializing the self-affine graphic symbol to be equal to the original graphic symbol; and
replacing the at least one portion of the self-affine graphic symbol with a scaled down version of the original graphic symbol.

6. The method of claim 1, wherein the data item comprises a Uniform Resource Identifier (URI).

7. The method of claim 1, wherein the data item comprises an identifier of a virtual meeting, and wherein causing the self-affine graphic symbol to be visually rendered for presentation to one or more users further comprises:
projecting the self-affine graphic symbol on a surface viewable by the one or more users from different distances.

8. The method of claim 1, wherein the data item comprises an instruction for utilizing an equipment item, and wherein causing the self-affine graphic symbol to be visually rendered for presentation to one or more users further comprises:
attaching an image of the self-affine graphic symbol to the equipment item.

9. The method of claim 1, wherein causing the self-affine graphic symbol to be visually rendered for presentation to one or more users further comprises:
generating a watermark graphic symbol comprising the self-affine graphic symbol; and
incorporating the watermark graphic symbol into content to be presented to the one or more users.

10. A system comprising:
a memory device; and
a processing device coupled to the memory device, the processing device to perform operations comprising:
receiving, by the processing device, a data item;
encoding the data item into an original graphic symbol;
generating, based on the original graphic symbol, a self-affine graphic symbol; and
causing the self-affine graphic symbol to be visually rendered for presentation to one or more users.

11. The system of claim 10, wherein the original graphic symbol is represented by a matrix barcode.

12. The system of claim 10, wherein at least one portion of the self-affine graphic symbol is derived from the original graphic symbol by applying an affine transformation to the original graphic symbol.

13. The system of claim 12, wherein the affine transformation is represented by an isotropic affine transformation.

14. The system of claim 12, wherein generating the self-affine graphic symbol further comprises:
initializing the self-affine graphic symbol to be equal to the original graphic symbol; and
replacing the at least one portion of the self-affine graphic symbol with a scaled down version of the original graphic symbol.

15. A non-transitory machine-readable storage medium storing instructions which, when executed, cause a processing device to perform operations comprising:
receiving, by the processing device, a data item;
encoding the data item into an original matrix barcode;
generating, based on the original matrix barcode, a self-affine matrix barcode; and
causing the self-affine matrix barcode to be visually rendered for presentation to one or more users.

16. The non-transitory machine-readable storage medium of claim 15, wherein at least one portion of the self-affine matrix barcode is derived from the original matrix barcode by applying an affine transformation to the matrix barcode.

17. The non-transitory machine-readable storage medium of claim 16, wherein generating the self-affine matrix barcode further comprises:
initializing the self-affine matrix barcode to be equal to the original matrix barcode; and
replacing the at least one portion of the self-affine matrix barcode with a scaled down version of the original matrix barcode.

18. The non-transitory machine-readable storage medium of claim 15, wherein the original graphic symbol is represented by a matrix barcode.

19. The non-transitory machine-readable storage medium of claim 15, wherein the affine transformation is represented by an isotropic affine transformation.

20. The non-transitory machine-readable storage medium of claim 15, wherein the data item comprises a Uniform Resource Identifier (URI).
